(19) United States
(12) Patent Application Publication
(10) Pub. No.: US 2008/0093891 A1
(43) Pub. Date: Apr. 24, 2008

(54) MOTOR VEHICLE COMPONENT AND METHOD

(76) Inventors: Guido Benvenuto, Lasalle (CA); C. Patrick Martyn, Harrow (CA); A. Tony Falconio, Amherstburg (CA); Robert Desantis, Lasalle (CA)

Correspondence Address: GIFFORD, KRASS, SPRINKLE,ANDERSON & CITKOWSKI, P.C, PO BOX 7021, TROY, MI, 48007-7021, US

(21) Appl. No.: 11/762,971

(22) Filed: Jun. 14, 2007

Related U.S. Application Data
(60) Provisional application No. 60/813,742, filed on Jun. 14, 2006.

(51) Int. Cl. B62D 25/08

(52) U.S. Cl. 296/192; 264/251

(57) ABSTRACT

Disclosed is a unitary cowl top ventilation component for a motor vehicle. The component includes structural and elastomeric portions molded into a single unitary body. Also disclosed are methods for malting the component.

### CROSS-REFERENCE TO RELATED APPLICATIONS

This application claims priority of U.S. Provisional Patent Application Ser. No. 60/813,742 filed Jun. 14, 2006, entitled “Motor Vehicle Component and Method.”

### FIELD OF THE INVENTION

This invention relates generally to nonmetallic components of motor vehicles and to methods for their manufacture. More specifically, the invention relates to injection molded components of motor vehicles, comprising rigid, structural polymeric members having integral seals, formed from an elastomeric polymer, bonded thereto. Most specifically, the invention relates to a cowl top ventilator component for a motor vehicle and to methods for its manufacture.

### BACKGROUND OF THE INVENTION

The cowl top ventilator is a component of a motor vehicle which operates to bridge the space between the windshield, hood and other body components of the motor vehicle while allowing for entry of outside air into the heating, ventilation and air conditioning system of the vehicle. The cowl must further operate to exclude exhaust and other vapors from the engine compartment so that such materials will not enter the passenger cabin of the motor vehicle. The cowl component must further operate to exclude water from the passenger cabin and the engine compartment of the vehicle. In the prior art, such cowl top ventilator assemblies were typically multicomponent structures fabricated from a rigid structural material such as metal or a high-strength polymer, and further incorporating a plurality of separate sealing gaskets. The multipart nature of these assemblies complicates the inventory, handling and installation of the cowl top ventilators, and can also lead to problems with the quality of the water or gas-tight seal provided thereby. As a consequence, such assemblies are costly and difficult to use.

As will be explained in detail hereinbelow, the present invention provides for a unitary cowl top ventilator component which is fabricated from a high strength structural polymer and includes a series of integral seals, comprised of a polymeric material, molded thereonto. The components of the present invention are preferably manufactured by a multiple shot injection molding process which provides for a tight, fusion bond between the structural material and the sealing material. As a consequence, high quality, integral, permanently bonded seals are provided.

### BRIEF DESCRIPTION OF THE INVENTION

Disclosed is a unitary cowl top ventilator component for a motor vehicle. The component comprises a rigid polymeric body having a channel configured to receive a windshield of a motor vehicle and/or a hood-engaging portion. A first body of an elastomeric material is bonded to the channel portion and operates to engage the edge of a windshield disposed in the channel. A second body of elastomeric material is bonded in the channel and engages the face of the windshield. An optional third member may engage a hood of a motor vehicle, and an optional fourth member may engage a plenum of the vehicle. Also disclosed are injection molding methods for manufacturing the component.

### BRIEF DESCRIPTION OF THE DRAWINGS

FIG. 1 is a cross-sectional view of portions of a cowl ventilator component;

FIG. 2 is a schematic depiction for a molding process which may be used to manufacture the cowl of FIG. 1;

FIG. 3 depicts a further step in the molding process; and

FIG. 4 and FIG. 5 depict portions of the cowl component.

### DETAILED DESCRIPTION OF THE INVENTION

In a typical component of the present invention, a first seal or set of seals establishes contact with the windshield of the motor vehicle, and in this regard may include one seal which engages the edge of the glass and another which engages a face of the glass proximate its perimeter. The component may further include another seal which engages the hood portion of the motor vehicle and operates to seal the engine compartment, and yet a third seal which engages the plenum wall of the motor vehicle.

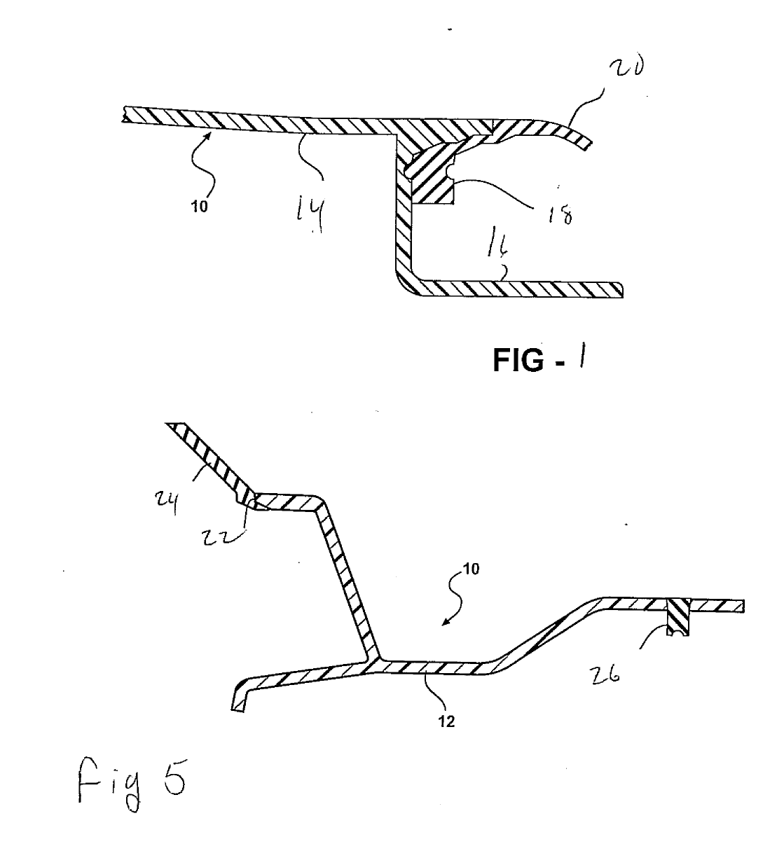

Referring now to FIG. 1, there is shown a cross-sectional view of two pieces 10, 12 of a cowl top ventilator component of the present invention. The first piece 10 represents the windshield-engaging portion, and the second piece 12 represents the hood-engaging portion of the component. Now with reference to the first section of the component 10, it will be seen that the component is comprised of a structural member 14, typically fabricated from a high strength polymer such as nylon, ABS, polypropylene, ASA, PC, other thermoplastic polyolefins (TPO) or the like. This polymer may, as is known in the art, be reinforced with a material such as glass fiber, carbon fiber, mineral material, metallic material or the like, so as to increase its strength. As shown in FIG. 1, the structural member 14 includes a channel portion 16 which is configured to engage the windshield of a motor vehicle. Integral with, and bonded to, the channel portion 16 is a first body of elastomeric polymer 18 which forms a sealing member which engages an edge of a windshield (not shown). A second body of a thermoplastic elastomeric material 20 forms a front, flange-like seal which contacts the face of the windshield, proximate at least one edge thereof. As shown herein, the two sealing portions 18, 20 are contiguous, although it is to be understood that they may be separate bodies. The thermoplastic elastomeric material may comprise natural rubbers, synthetic rubbers, copolymers, as well as any other natural or synthetic material providing the requisite combination of strength and resiliency.

The second portion of the cowl top ventilator component 12 also includes a portion of the structural member 14 as discussed above. The structural member 14 is configured to include a hood-engaging portion 22, and in accord with the present invention, a body of elastomeric material 24 is fusion bonded to the structural member 14. As shown, this body of elastomeric material 24 forms a flange seal operable to engage a portion of the hood of a motor vehicle. As is further shown in FIG. 1, yet another body of elastomeric material is bonded to the structural member 14. This body of elastomeric material 26 defines a plenum seal which engages the plenum of the motor vehicle and aids in sealing the passenger compartment from the engine compartment. Depending on the particular configuration of motor vehicle, the physical dimensions and shape of the cowl top ventilator component may vary. For example, the number or placement of the elastomeric seals may vary as may the basic shape of the structural member. All of such modifications and variations are within the scope of the present invention.

Various processes may be used to fabricate the components of the present invention. Injection molding is one particular method which may be employed, and multiple shot injection molding is a specific type of injection molding which may be used with advantage in the present invention. In such processes, different types of molding material may be simultaneously or sequentially injected into a mold to fabricate unitary articles having different types of material fusion bonded to one another. Within the context of this disclosure, fusion bonding shall refer to bonds formed by contacting bodies of material together when at least one of those materials is in a molten state.

FIG. 2 is a schematic depiction of a first step in a molding process wherein articles of the present type may be fabricated. Such molding processes are generically referred to as retracting blade processes, since a retractable masking blade or other such member is employed to control the flow of molding material in a mold cavity. As is shown in FIG. 2, a structural member of the component is formed in a first step by injection molding a high strength polymeric material into a mold cavity. FIG. 2 shows only a portion of the structural component, in this instance the window channel portion 10, although it is to be understood that the entire member is molded in this first step. As will be seen, the molding apparatus includes a first slide member 30 which engages and defines a portion of the channel surface of the structural member segment 10. As will be explained in detail below, this slide 30 will be moved in subsequent steps. The slide 30 includes a gate 32, termed a cashew gate, which in subsequent steps will operate to deliver a second molding material to the system. This gate 32 is in communication with a source of elastomeric polymeric material 34, but in the FIG. 2 configuration it is in a forward position and not operable to deliver polymeric material thereto.

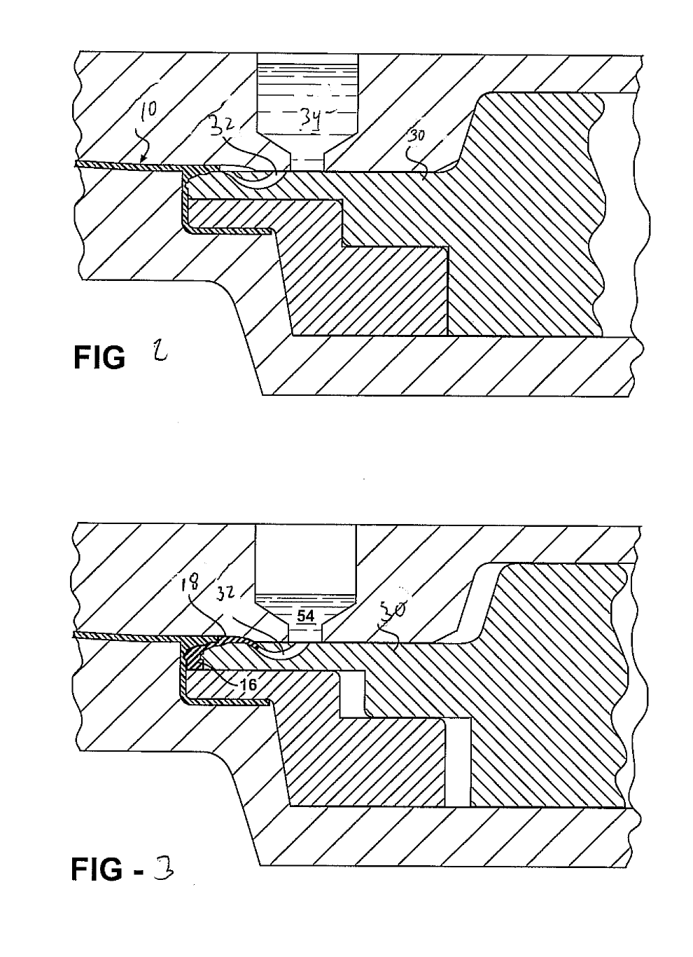

Referring now to FIG. 3, there is shown a subsequent step in the operation which is carried out after the injection of the material comprising the structural member 10. In this stage of the process, the slide 30 is withdrawn thereby defining a further mold cavity corresponding to the aforedescribed seals 18 and 20. By withdrawing slide 30, the injection gate 32 is placed in communication with the source of elastomeric polymer 34, and this material is then injected into the newly opened cavity so as to form the elastomeric bodies 18 and 20. The result of this process is that elastomeric polymer is fusion bonded to the high strength structural polymer thereby providing a composite component having structural integrity and integral sealing members.

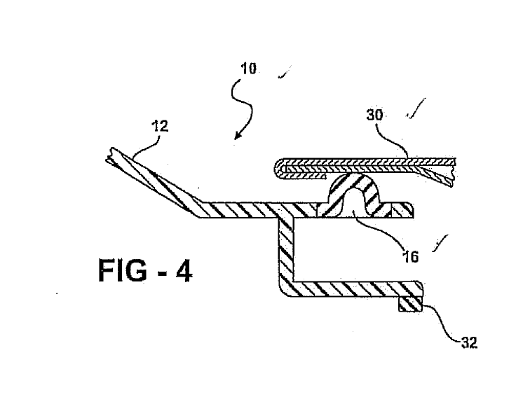

The hood seal and plenum seal are similarly molded as will be seen from FIGS. 4 and 5. Typically, the hood and plenum seals are molded concomitant with the window contacting seal, although the various seal members may be formed sequentially.

The foregoing represents one system for fabricating the component of the present invention. Other molding systems, including transfer molding systems as well as yet other systems operative to mold multimaterial articles, may be adapted for the practice of the present invention.

In view of the foregoing, it will be appreciated by one of skill in the art that yet other embodiments and modifications of the system may be implemented. Therefore, it is to be understood that the foregoing drawings, discussion and description are illustrative of particular embodiments of the invention, but are not meant to be limitations upon the practice thereof. It is the following claims, including all equivalents, which define the scope of the invention.

1. A unitary cowl top ventilator component for a motor vehicle, said component comprising:
a body of a rigid polymeric material defining a structural member of said component, said structural member including a channel portion configured to receive a windshield of a motor vehicle, and/or a hood-engaging portion;
a first body of an elastomeric polymer bonded to the channel portion of the structural member, said first body defining a first sealing member configured to engage an edge of a windshield disposed in the channel portion; and
a second body of an elastomeric polymer bonded to the channel portion of the structural member, said second body defining a second sealing member configured to engage the face of a windshield disposed in said channel portion.

2. The component of claim 1, further including a third body of an elastomeric polymer bonded to the hood-engaging portion of the structural member, said third body defining a flexible flange configured to engage a hood of a motor vehicle.

3. The component of claim 2, further including a fourth body of an elastomeric polymer bonded to said structural member, said fourth body defining a plenum seal configured to engage a plenum of a motor vehicle.

4. The component of claim 1, wherein said second seal is configured as a flange which is operable to engage a portion of the face of a windshield proximate a portion of the perimeter thereof.

5. The component of claim 1, wherein all of the bodies of elastomeric material are fabricated from the same polymer.

6. The component of claim 1, wherein at least one of the bodies of elastomeric material is fabricated from a polymer which is different from the polymeric material of the other bodies of elastomeric material.

7. The component of claim 1, wherein the first and second bodies of elastomeric polymer are contiguous.

8. The component of claim 1, wherein the elastomeric polymer is one or more of a natural rubber, a synthetic rubber, and a copolymer.

9. The component of claim 1, wherein the rigid polymer is selected from the group consisting of nylon, ABS, polypropylene, TPO, ASA, PC and combinations thereof.

10. The component of claim 1, wherein said component is manufactured by an injection molding process.

11. The component of claim 10, wherein said injection molding process is a multiple shot injection molding process wherein in a first step, the rigid polymeric material is injected into a mold cavity so as to form the structural member; and whereas in a second step of the process at least one of the first, second or third bodies of elastomeric polymeric material is injected into the mold cavity so as to bond to the material comprising the structural member.

12. The component of claim 11, wherein in the first step of said injection molding process, said mold cavity includes a retractable blade or like member which projects into the mold cavity and prevents the rigid polymer from entering preselected portions of the cavity; and whereas in a second step, the blade member is withdrawn so as to permit the elastomeric polymer to enter into those preselected portions of the cavity.
